(19) United States
(12) Patent Application Publication
(10) Pub. No.: US 2020/0096306 A1
(43) Pub. Date: Mar. 26, 2020

(54) METHOD AND APPARATUS FOR MEASURING A CIRCUMFERENTIAL TOOTHING CONTOUR OF A TOOTHED REVOLVING OBJECT

(71) Applicant: REGINALD GALESTIEN, KLAZIENAVEEN (NL)

(72) Inventor: REGINALD GALESTIEN, KLAZIENAVEEN (NL)

(21) Appl. No.: 16/619,262

(22) PCT Filed: Oct. 19, 2017
(86) PCT No.: PCT/NL2017/050687

§ 371 Date: Dec. 4, 2019

(30) Foreign Application Priority Data
Jun. 6, 2017 (NL) 1042417

(51) Int. Cl. G01B 5/20

(52) U.S. Cl. CPC G01B 5/202

(57) ABSTRACT

The invention provides a solution according to which many various circumferential toothing contours (93) of many various toothed revolving objects (90) can be measured accurately and quickly by means of an inexpensive apparatus (1). In concise summary, the key features of the invention are formed by detective tracing actions of two asymmetrically sharp tracer fingers (11, 12), wherein said detective tracing actions take place at opposite tooth flanks (91, 92) during opposite rotation directions (41, 42) between the tracer fingers and the circumferential toothing.

The invention relates to a method and an apparatus for accurately measuring at least part of a circumferential toothing contour of internal or external toothing of a toothed revolving object, wherein said circumferential toothing contour occurs in a cross-sectional plane perpendicular to a central revolving axis of the toothed revolving object, and wherein said circumferential toothing contour has a plurality of pairs of mutually opposite first and second contour flanks corresponding to a plurality of pairs of mutually opposite first and second tooth flanks, respectively, of a corresponding plurality of teeth of said toothing, respectively.

Such a toothed revolving object, as usable in connection with the invention, may be of many various types, forms and dimensions. It may for example be a toothed disc, drum, roller, shaft, wheel, spline gauge, or the like. It may be at least partly conical and/or nonconical and/or its toothing may be at least partly helical and/or nonhelical. It may have large sizes, e.g. when used in a gearbox for cars, as well as small sizes, e.g. when used in a mechanism for watches.

Various testing apparatus are known for detecting imperfections in circumferential toothing contours of revolving objects. For example, US 2003/0037626 A1 discloses an apparatus for testing gears by rolling without backlash with a mating gear, generally a master gear. However, this known gear testing apparatus is not suitable for accurately measuring circumferential toothing contours of revolving objects.

For accurately measuring contours of objects, including circumferential toothing contours of revolving objects, various multi-dimensional CNC measuring apparatus are known. For example, WO2013060317A1 discloses such a measuring apparatus. A drawback of these kinds of apparatus is that they are expensive. Another drawback of these kinds of apparatus is that, in many cases of measuring specific circumferential toothing contours, it takes long operation times to obtain accurate measurement results.

It is an object of the invention to provide a solution according to which many various circumferential toothing contours of many various toothed revolving objects can be measured accurately and quickly by means of an inexpensive apparatus.

For that purpose the invention provides a method according to the appended independent claim 1, as well as an apparatus according to the appended independent claim 4. Preferable embodiments of the invention are provided by the appended dependent claims 2-3 and 5-6.

Hence, the invention provides a method for accurately measuring at least part of a circumferential toothing contour of internal or external toothing of a toothed revolving object, wherein said circumferential toothing contour occurs in a cross-sectional plane perpendicular to a central revolving axis of the toothed revolving object, and wherein said circumferential toothing contour has a plurality of pairs of mutually opposite first and second contour flanks corresponding to a plurality of pairs of mutually opposite first and second tooth flanks, respectively, of a corresponding plurality of teeth of said toothing, respectively, the method comprising:
providing an apparatus comprising:
   an apparatus frame,
   a holding structure connected to said apparatus frame and configured for effecting a holding condition in which the holding structure is holding the toothed revolving object,
   a tracing structure connected to said apparatus frame and comprising a first tracer finger and a second tracer finger, wherein the first tracer finger comprises a first tracer bevel surface and a first tracer point, wherein the first tracer finger by said first tracer bevel surface is asymmetrically narrowing in its longitudinal direction up to said first tracer point, being a free end of the first tracer finger, and wherein the second tracer finger comprises a second tracer bevel surface and a second tracer point, wherein the second tracer finger by said second tracer bevel surface is asymmetrically narrowing in its longitudinal direction up to said second tracer point, being a free end of the second tracer finger,
   a driving structure configured for effecting in said holding condition a first relative rotation between the toothed revolving object and the first tracer finger in a first rotation direction around said central revolving axis, and for effecting a second relative rotation between the toothed revolving object and the second tracer finger in a second rotation direction around said central revolving axis, wherein said first and second rotation directions are mutually opposite,
   a processor for determining a measured shape of said circumferential toothing contour based on detected first relative positions of said first tracer point relative to said toothed revolving object during said first relative rotation, and based on detected second relative positions of said second tracer point relative to said toothed revolving object during said second relative rotation,
performing a first tracing phase, during which the first tracer finger is tracing against and along said circumferential toothing contour by performing said first relative rotation, wherein the first tracing phase comprises:
   first tracing subphases, during which the first tracer point is tracing against and along at least said first contour flanks, and
   first nontracing subphases, during which the first tracer point is prevented from tracing against and along at least part of said second contour flanks in that the first tracer bevel surface is contacting said toothing then,
performing a second tracing phase, during which the second tracer finger is tracing against and along said circumferential toothing contour by performing said second relative rotation, wherein the second tracing phase comprises:
   second tracing subphases, during which the second tracer point is tracing against and along at least said second contour flanks, and
   second nontracing subphases, during which the second tracer point is prevented from tracing against and along at least part of said first contour flanks in that the second tracer bevel surface is contacting said toothing then,
determining, by said processor, said measured shape of said circumferential toothing contour based on said first relative positions detected during said first tracing subphases and based on said second relative positions detected during said second tracing subphases.

In concise summary, the key features of the invention are formed by detective tracing actions of two asymmetrically sharp tracer fingers, wherein said detective tracing actions take place at opposite tooth flanks during opposite rotation directions between the tracer fingers and the circumferential toothing. These combined key features provide a highly accurate and highly efficient means specifically dedicated to measuring many various circumferential toothing contours of many various revolving objects, while said highly accurate and highly efficient means at the same time is non-complex and therefore inexpensive to realize.

In a preferable embodiment of a method according to the invention:
the tracing structure is configured for effecting that during said first tracing phase the first tracer finger has a one-dimensional tracing movement freedom along a one-dimensional first tracing path relative to said central revolving axis of the toothed revolving object, and the tracing structure is adjustable for adjusting the direction of said one-dimensional first tracing path relative to said central revolving axis; and/or
the tracing structure is configured for effecting that during said second tracing phase the second tracer finger has a one-dimensional tracing movement freedom along a one-dimensional second tracing path relative to said central revolving axis of the toothed revolving object, and the tracing structure is adjustable for adjusting the direction of said one-dimensional second tracing path relative to said central revolving axis.

Thanks to said adjustabilities of the tracing structure as regards the movement direction of the tracing finger(s), the apparatus is easily and effectively adaptable to specific circumferential toothing contours requiring dedicated accessibility of the tracer finger(s) from specific directions.

It is noted that said one-dimensional first tracing path may be a linear tracing path, but it may also be a curved tracing path, such as for example a circularly arched tracing path provided by a swivelling arm that holds the first tracing finger. Similarly, said one-dimensional second tracing path may be a linear tracing path, but it may also be a curved tracing path, such as for example a circularly arched tracing path provided by a swivelling arm that holds the second tracing finger.

In a further preferable embodiment of a method according to the invention:
the tracing structure in said holding condition is adjustable for adjusting an axial tracing position, as seen along said central revolving axis of the toothed revolving object, of the first and second tracer fingers relative to the toothed revolving object, and
the method is carried out multiple times for said toothed revolving object at a corresponding plurality of mutually adjusted ones of said axial tracing position, respectively, thereby determining a corresponding plurality of different ones of said measured shape, respectively, of a corresponding plurality of different ones of said circumferential toothing contour, respectively.

Thanks to said adjustability of the tracing structure as regards said axial tracing position, the apparatus allows for easily and effectively measuring many various helical toothings of many various revolving objects.

The abovementioned aspects and other aspects of the invention will be apparent from and elucidated with reference to the embodiments described hereinafter by way of non-limiting examples only and with reference to the schematic figures in the enclosed drawing.

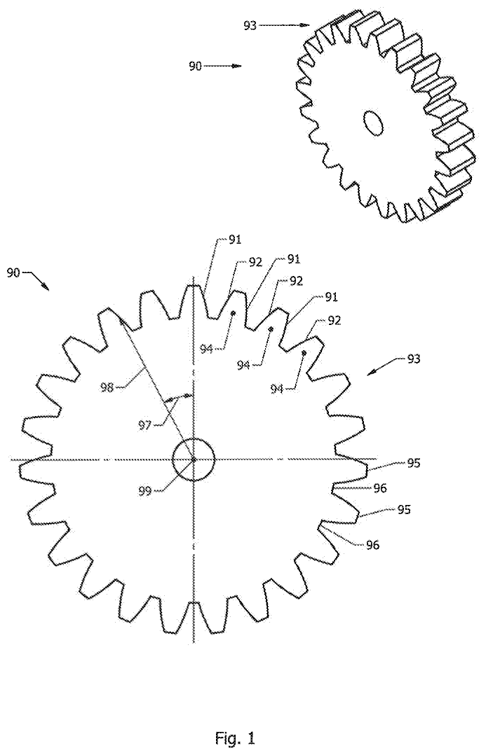

FIG. 1 shows an example of a toothed revolving object for use in connection with the invention, wherein the toothed revolving object is shown in a perspective view, and wherein a circumferential toothing contour of the toothed revolving object is shown in side view.

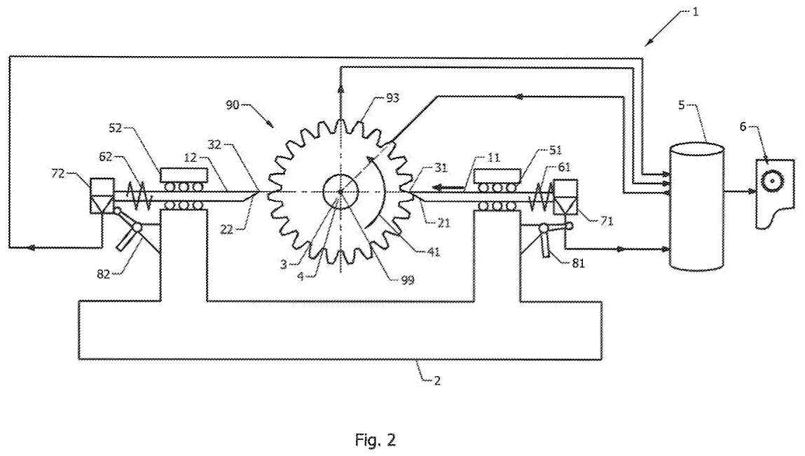

FIG. 2 shows, in a side view, an example of an embodiment of an apparatus according to the invention, while holding the toothed revolving object of FIG. 1, and while performing a first tracing phase of an example of an embodiment of a method according to the invention.

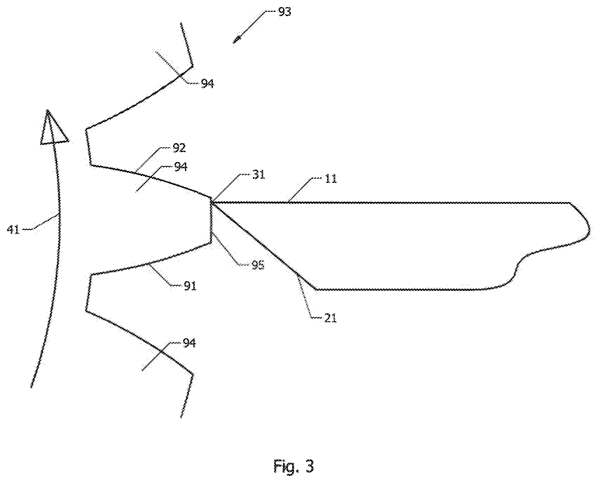

FIG. 3 shows an enlarged detail of the situation of FIG. 2, wherein a first tracer finger of the apparatus is tracing against and along a tooth of the toothed revolving object.

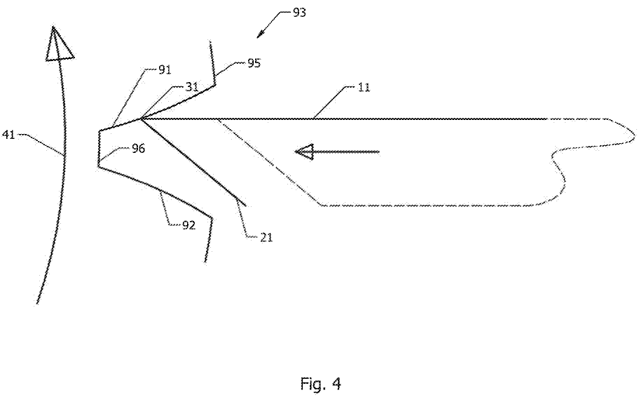

FIG. 4 shows the situation of FIG. 3 again, however, this time during performing a first tracing subphase of the first tracing phase.

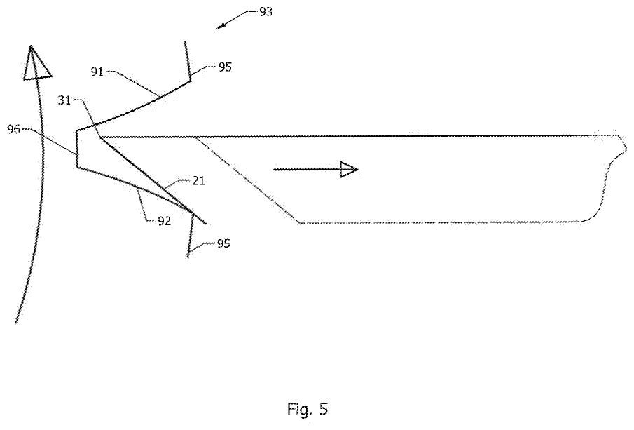

FIG. 5 also shows the situation of FIG. 3 again, however, this time during performing a first nontracing subphase of the first tracing phase.

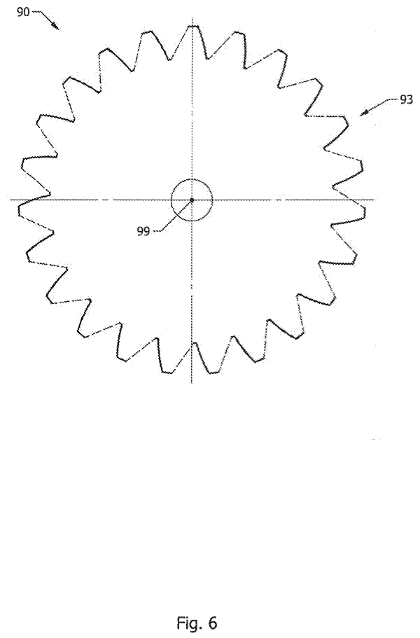

FIG. 6 shows the circumferential toothing contour of FIG. 1 again, however, wherein this time those parts of the circumferential toothing contour which are measured during first tracing subphases are indicated in full lines, while those parts of the circumferential toothing contour which are prevented from being measured during first nontracing subphases are indicated in broken lines.

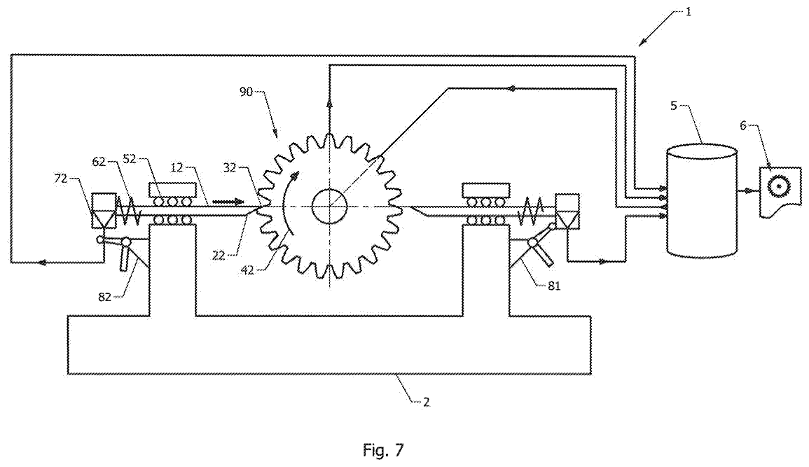

FIG. 7 shows the situation of FIG. 2 again, however, this time while performing a second tracing phase of an example of an embodiment of a method according to the invention.

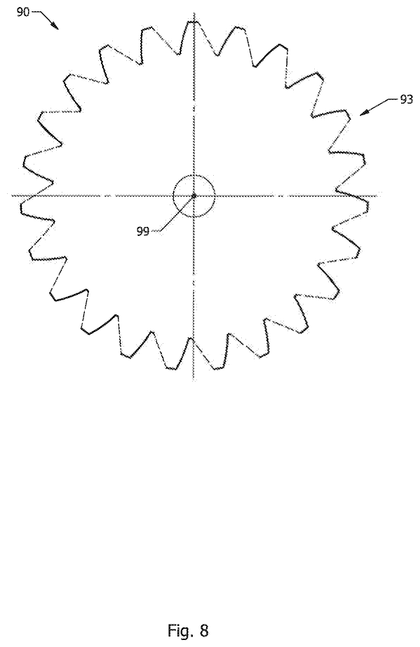

FIG. 8 shows the circumferential toothing contour of FIG. 6 again, however, wherein this time those parts of the circumferential toothing contour which are measured during second tracing subphases are indicated in full lines, while those parts of the circumferential toothing contour which are prevented from being measured during second nontracing subphases are indicated in broken lines.

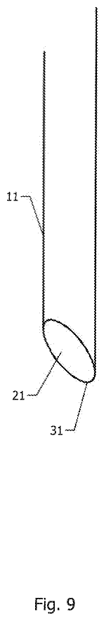

FIG. 9 shows, in a perspective view, an example of an embodiment of the first tracer finger of the apparatus of FIG. 2.

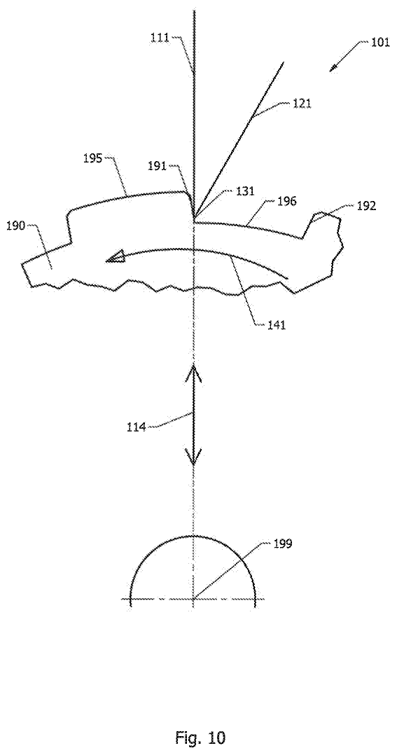

FIG. 10 shows a situation similar to FIG. 3, however, this time in connection with a further embodiment of the invention, wherein another toothed revolving object is used in connection with the invention.

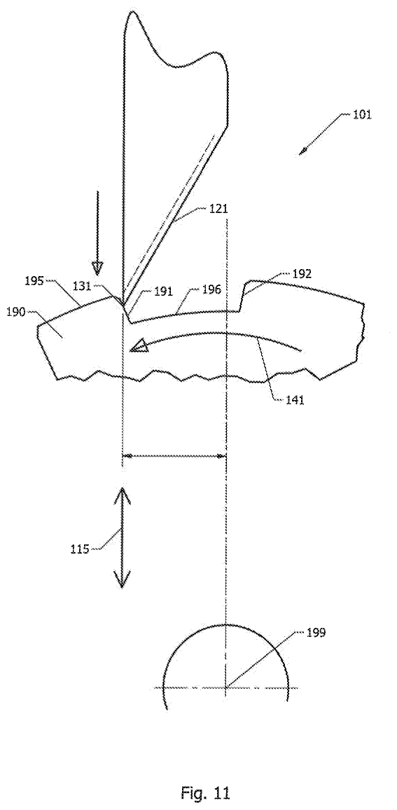

FIG. 11 shows the situation of FIG. 10 again, however, this time in a modified configuration to illustrate said another embodiment of the invention.

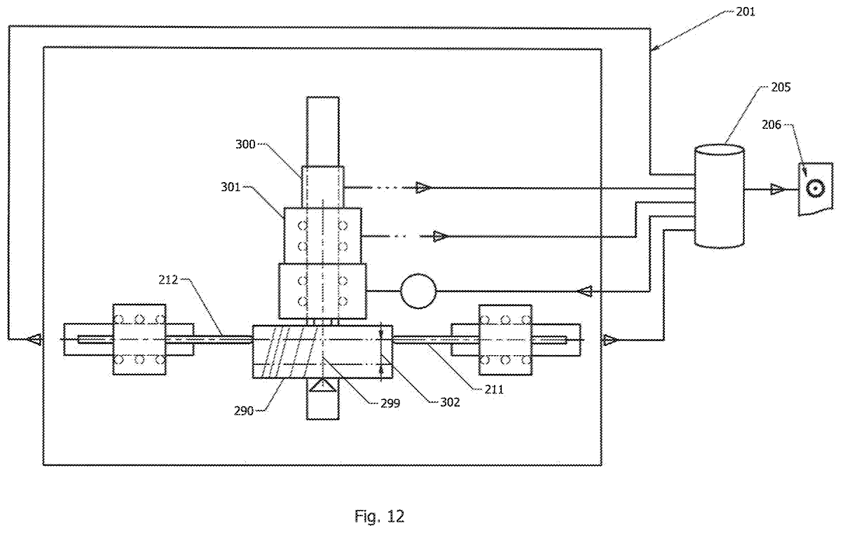

FIG. 12 shows, in a top view, a situation similar to FIG. 2, however, this time in connection with a yet further embodiment of the invention, wherein another apparatus is used in connection with the invention.

Now, reference is first made to the abovementioned FIGS. 1-9. The reference signs used in FIGS. 1-9 are referring to the abovementioned parts and aspects of the invention, as well as to related parts and aspects, in the following manner.
1 apparatus
2 apparatus frame
3 holding structure
4 driving structure
5 processor
6 measured shape
11 first tracer finger
12 second tracer finger
21 first tracer bevel surface
22 second tracer bevel surface
31 first tracer point
32 second tracer point
41 first rotation direction
42 second rotation direction
51 first linear guiding structure
52 second linear guiding structure
61 first tracing force system
62 second tracing force system
71 first position detector
72 second position detector
81 first tracer switch
82 second tracer switch
90 toothed revolving object
91 first contour flanks
92 second contour flanks
93 circumferential toothing contour
94 tooth
95 top of a tooth
96 bottom between two adjacent teeth
97 angle of polar coordinate system
98 radius of polar coordinate system
99 central revolving axis

Based on the above introductory description, including the above brief description of the drawing figures, and based on the above-explained reference numerals used in the drawing, the shown examples of FIGS. 1-9 are for the greatest part readily self-explanatory. The following extra explanations are given.

In FIG. 1 the circumferential toothing contour 93 can be described by the radius 98 as a function of the angle 97, wherein the radius 98 and the angle 97 are parameters of a polar coordinate system relative to the central revolving axis 99. In FIG. 1, the tops of the teeth 94 have been indicated by the reference numeral 95, while the groove bottoms between two adjacent teeth 94 have been indicated by the reference numeral 96.

FIG. 2 shows the apparatus 1, wherein the holding structure 3 is holding the toothed revolving object 90, and wherein the driving structure 4 is able to rotate the toothed revolving object 90 around the central revolving axis 99. In FIG. 2 both the holding structure 3 and the driving structure 4 are highly schematically represented by one and the same circular disc. In FIG. 2 an interconnecting line, which is pointing from the processor 5 towards the central revolving axis 99, schematically represents control of the driving structure 4 by the processor 5. Furthermore, in FIG. 2 a further interconnecting line, which is pointing from the central revolving axis 99 towards the processor 5, schematically represents inputting into the processor 5 of actually determined relative rotation positions of the toothed revolving object 90 around the central revolving axis 99, as seen relative to the apparatus frame 2. During rotation of the toothed revolving object 90, this inputting can take place many times per second, such as several thousand times per second.

In the example of FIG. 2, the tracing structure of the apparatus 1 comprises a first tracing substructure and a second tracing substructure.

The first tracing substructure comprises the first tracer finger 11, the first linear guiding structure 51, the first tracing force system 61, and the first position detector 71.

The first tracer finger 11 of FIG. 2 is separately shown in FIG. 9. In the shown example, the first tracer finger 11 is made by providing a cylindrical object with the first tracer bevel surface 21 to thereby obtain the first tracer point 31.

The first tracing force system 61 is configured for pushing the first tracer point 31 of the first tracer finger 11 with a controlled tracing force against the circumferential toothing contour 93.

The first position detector 71 is configured for detecting relative translation positions of the first tracer point 31 relative to the central revolving axis 99. In FIG. 2 a further interconnecting line, which is pointing from the first position detector 71 towards the processor 5, schematically represents inputting into the processor 5 of actually determined relative translation positions of the first tracer point 31 relative to the central revolving axis 99. During rotation of the toothed revolving object 90, this inputting can take place many times per second, such as several thousand times per second. The actually determined relative translation positions of the first tracer point 31 are to be determined simultaneously with the above-described actually determined relative rotation positions of the toothed revolving object 90.

In FIGS. 3-5, the first tracer finger 11 is tracing against and along the circumferential toothing contour 93, while the toothed revolving object 90 is rotating in the first rotation direction 41. This is during performing the first tracing phase. In FIG. 3 the first tracer point 31 is tracing against and along the top 95 of one tooth 94. In FIG. 4 the toothed revolving object 90 has been rotated a bit farther in the first rotation direction 41, as compared to FIG. 3. In FIG. 4 the first tracer point 31 is tracing against and along the first contour flank 91 of said one tooth 94. This is during performing a first tracing subphase of the first tracing phase. In FIG. 5 the toothed revolving object 90 has been rotated a bit farther in the first rotation direction 41, as compared to FIG. 4. In FIG. 5 the first tracer point 31 is prevented from tracing against and along a part of the bottom 96 between said one tooth 94 and its neighbouring tooth, and is prevented from tracing against and along the second contour flank 92 of said neighbouring tooth in that the first tracer bevel surface 21 is contacting the circumferential toothing contour 93 then. This is during performing a first nontracing subphase of the first tracing phase.

FIG. 6 shows the circumferential toothing contour 93 once again. In FIG. 6 the full lines represent those parts of the circumferential toothing contour 93 which have been measured during the first tracing subphases after rotation in the first rotation direction 41 over at least 360 degrees.

As mentioned, the tracing structure of the apparatus 1 not only comprises the above-explained first tracing substructure, but also a second tracing substructure. This second tracing substructure is analogous to the first tracing substructure. See FIG. 2. That is, the first tracing substructure comprises the second tracer finger 12, the second linear guiding structure 52, the second tracing force system 62, and the second position detector 72, all being analogous to the first tracer finger 11, the first linear guiding structure 51, the first tracing force system 61, and the first position detector 71, respectively.

The first and second tracing substructures further comprise the mutually analogous first and second tracer switches 81 and 82, respectively. In FIG. 2 the first tracer switch 81 is enabling the operation of the first tracer finger 11, while the second tracer switch 82 is disabling the operation of the second tracer finger 12.

FIG. 7 shows the situation of FIG. 2 again, however, this time while performing a second tracing phase of an example of an embodiment of a method according to the invention. That is, in FIG. 7 the toothed revolving object 90 is rotating in the second rotation direction 42. Furthermore, in FIG. 7 the first tracer switch 81 is disabling the operation of the first tracer finger 11, while the second tracer switch 82 is enabling the operation of the second tracer finger 12.

It is noted that FIGS. 2 and 7 further show a further interconnecting line, which is pointing from the second position detector 72 towards the processor 5. This further interconnecting line schematically represents inputting into the processor 5 of actually determined relative translation positions of the second tracer point 32 relative to the central revolving axis 99. During rotation of the toothed revolving object 90, this inputting can take place many times per second, such as several thousand times per second. The actually determined relative translation positions of the second tracer point 32 are to be determined simultaneously with the actually determined relative rotation positions of the toothed revolving object 90.

FIG. 8 shows the circumferential toothing contour 93 once again. In FIG. 8 the full lines represent those parts of the circumferential toothing contour 93 which have been measured during the second tracing subphases after rotation in the second rotation direction 42 over at least 360 degrees.

Based on the above explanations it will be readily appreciated that by combining the measured information obtained during the first and second tracing subphases, i.e. the measured information as represented by the full lines of FIG. 6 and FIG. 8, respectively, a complete shape of the circumferential toothing contour 93 can be accurately measured according to the present invention.

Next, reference is made to the further embodiment of FIGS. 10-11, which serve to illustrate the abovementioned preferable embodiment of a method according to the invention, wherein:
the tracing structure is configured for effecting that during said first tracing phase the first tracer finger has a one-dimensional tracing movement freedom along a one-dimensional first tracing path relative to said central revolving axis of the toothed revolving object, and the tracing structure is adjustable for adjusting the direction of said one-dimensional first tracing path relative to said central revolving axis; and/or
the tracing structure is configured for effecting that during said second tracing phase the second tracer finger has a one-dimensional tracing movement freedom along a one-dimensional second tracing path relative to said central revolving axis of the toothed revolving object, and the tracing structure is adjustable for adjusting the direction of said one-dimensional second tracing path relative to said central revolving axis.

It was already mentioned above that, thanks to said adjustabilities of the tracing structure as regards the movement direction of the tracing finger(s), the apparatus is easily and effectively adaptable to specific circumferential toothing contours requiring dedicated accessibility of the tracer finger(s) from specific directions. This is now further illustrated as follows.

In the further embodiment of FIGS. 10-11 parts and aspects, which are similar to the parts and aspects shown in FIGS. 1-9, are indicated by increasing the corresponding reference numerals of FIGS. 1-9 by the integer value 100. For example, in FIGS. 10-11 the reference numeral 101 indicates the apparatus of this further embodiment of the invention, the reference numeral 190 indicates the toothed revolving object of this further embodiment, and the reference numeral 199 indicates the central revolving axis of this toothed revolving object 190.

In FIG. 10 the reference numeral 114 indicates a certain direction of the abovementioned one-dimensional first tracing path, wherein said direction 114 intersects the central revolving axis 199 of the toothed revolving object 190.

In FIG. 10 it is seen that the first contour flank 191 is relatively steep. In fact, during the first tracing phase, the first contour flank 191 has almost the same direction as the direction 114 of the one-dimensional first tracing path. Due to this circumstance, the first tracer point 131 will experience difficulties in following the contour of the first contour flank 191 from the top 195 of the tooth to the bottom 196 between two adjacent teeth. This will result into decreased measuring accuracy.

In FIG. 11 the reference numeral 115 indicates an adjusted direction of the abovementioned one-dimensional first tracing path, as compared to the direction 114 of FIG. 10. This adjusted direction 115 does not intersect the central revolving axis 199 of the toothed revolving object 190. Instead, the adjusted direction 115 crosses the central revolving axis 199 at a suitably adjusted distance. It clearly follows that in FIG. 11 the angle between the direction of the first contour flank 191 and the direction 115 of the one-dimensional first tracing path is larger than the angle between the direction of the first contour flank 191 and the direction 114 of the one-dimensional first tracing path in FIG. 10. Accordingly, in FIG. 11 the first tracer point 131 will follow the contour of the first contour flank 191 more easily than in FIG. 10, resulting in increased accuracy of measuring the first contour flank 191 during the first tracing phase.

It is readily apparent that increased accuracy of measuring the second contour flank 192 during the second tracing phase can be obtained in a similar manner as explained above for the first contour flank 191 during the first tracing phase.

Next, reference is made to the yet further embodiment of FIG. 12, which serves to illustrate the abovementioned further preferable embodiment of a method according to the invention, wherein:
the tracing structure in said holding condition is adjustable for adjusting an axial tracing position, as seen along said central revolving axis of the toothed revolving object, of the first and second tracer fingers relative to the toothed revolving object, and
the method is carried out multiple times for said toothed revolving object at a corresponding plurality of mutually adjusted ones of said axial tracing position, respectively, thereby determining a corresponding plurality of different ones of said measured shape, respectively, of a corresponding plurality of different ones of said circumferential toothing contour, respectively.

It was already mentioned above that, thanks to said adjustability of the tracing structure as regards said axial tracing position, the apparatus allows for easily and effectively measuring many various helical toothings of many various revolving objects. This is now further illustrated as follows.

In the yet further embodiment of FIG. 12 parts and aspects, which are similar to the parts and aspects shown in FIGS. 1-9, are indicated by increasing the corresponding reference numerals of FIGS. 1-9 by the integer value 200. For example, in FIG. 12 the reference numeral 201 indicates the apparatus of this yet further embodiment of the invention, the reference numeral 290 indicates the toothed revolving object of this yet further embodiment, and the reference numeral 299 indicates the central revolving axis of this toothed revolving object 290.

In FIG. 12 the reference numeral 300 indicates an axial displacement transducer of the apparatus 201, while the reference numeral 301 indicates an angular displacement transducer of the apparatus 201.

With the apparatus 201 a measuring method as discussed above can be carried out for a first time at a first axial tracing position. During this first time a first measured shape of a first circumferential toothing contour of the toothed revolving object 290 at said first axial tracing position is determined based on performing the abovementioned first and second tracing phases with the first and second tracing fingers 211 and 212, respectively.

Next, the toothed revolving object 290 is axially displaced parallel with the revolving axis 299 over a distance 302, while this distance 302 is measured by the axial displacement transducer 300.

Next, the measuring method is carried out for a second time, this time however at a second axial tracing position, which differs from the first axial tracing position by the abovementioned distance 302. During this second time a second measured shape of a second circumferential toothing contour of the toothed revolving object 290 at said second axial tracing position is determined based on performing the abovementioned first and second tracing phases with the first and second tracing fingers 211 and 212, respectively.

By comparing and analyzing the determined first and second circumferential toothing contours relative to one another it is possible to calculate for example the helix or taper of the toothing of the toothed revolving object 290.

While the invention has been described and illustrated in detail in the foregoing description and in the drawing figures, such description and illustration are to be considered exemplary and/or illustrative and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. For the purpose of clarity and a concise description, features are disclosed herein as part of the same or separate embodiments, however, it will be appreciated that the scope of the invention may include embodiments having combinations of all or some of the features disclosed. The mere fact that certain measures are recited in mutually different dependent claims does not indicate that a combination of these measures can not be used to advantage. Any reference signs in the claims should not be construed as limiting the scope.

1. A method for accurately measuring at least part of a circumferential toothing contour (93) of internal or external toothing of a toothed revolving object (90), wherein said circumferential toothing contour occurs in a cross-sectional plane perpendicular to a central revolving axis (99) of the toothed revolving object, and wherein said circumferential toothing contour has a plurality of pairs of mutually opposite first (91) and second (92) contour flanks corresponding to a plurality of pairs of mutually opposite first and second tooth flanks, respectively, of a corresponding plurality of teeth (94) of said toothing, respectively, the method comprising:
providing an apparatus (1) comprising:
an apparatus frame (2),
a holding structure (3) connected to said apparatus frame and configured for effecting a holding condition in which the holding structure is holding the toothed revolving object (90),
a tracing structure connected to said apparatus frame and comprising a first tracer finger (11) and a second tracer finger (12), wherein the first tracer finger comprises a first tracer bevel surface (21) and a first tracer point (31), wherein the first tracer finger by said first tracer bevel surface is asymmetrically narrowing in its longitudinal direction up to said first tracer point, being a free end of the first tracer finger, and wherein the second tracer finger (12) comprises a second tracer bevel surface (22) and a second tracer point (32), wherein the second tracer finger by said second tracer bevel surface is asymmetrically narrowing in its longitudinal direction up to said second tracer point, being a free end of the second tracer finger,
a driving structure (4) configured for effecting in said holding condition a first relative rotation between the toothed revolving object and the first tracer finger (11) in a first rotation direction (41) around said central revolving axis, and for effecting a second relative rotation between the toothed revolving object and the second tracer finger (12) in a second rotation direction (42) around said central revolving axis, wherein said first and second rotation directions are mutually opposite,
a processor (5) for determining a measured shape (6) of said circumferential toothing contour based on detected first relative positions of said first tracer point (31) relative to said toothed revolving object (90) during said first relative rotation, and based on detected second relative positions of said second tracer point (32) relative to said toothed revolving object (90) during said second relative rotation,
performing a first tracing phase, during which the first tracer finger (11) is tracing against and along said circumferential toothing contour (93) by performing said first relative rotation, wherein the first tracing phase comprises:
first tracing subphases, during which the first tracer point (31) is tracing against and along at least said first contour flanks (91), and
first nontracing subphases, during which the first tracer point (31) is prevented from tracing against and along at least part of said second contour flanks (92) in that the first tracer bevel surface (21) is contacting said toothing then,
performing a second tracing phase, during which the second tracer finger (12) is tracing against and along said circumferential toothing contour (93) by performing said second relative rotation, wherein the second tracing phase comprises:
second tracing subphases, during which the second tracer point (32) is tracing against and along at least said second contour flanks (92), and
second nontracing subphases, during which the second tracer point (32) is prevented from tracing against and along at least part of said first contour flanks (91) in that the second tracer bevel surface (22) is contacting said toothing then,
determining, by said processor (5), said measured shape (6) of said circumferential toothing contour (93) based on said first relative positions detected during said first tracing subphases and based on said second relative positions detected during said second tracing subphases.

2. A method according to claim 1, wherein:
the tracing structure is configured for effecting that during said first tracing phase the first tracer finger has a one-dimensional tracing movement freedom along a one-dimensional first tracing path relative to said central revolving axis (199) of the toothed revolving object (190), and the tracing structure is adjustable for adjusting the direction (114, 115) of said one-dimensional first tracing path relative to said central revolving axis (199); and/or
the tracing structure is configured for effecting that during said second tracing phase the second tracer finger has a one-dimensional tracing movement freedom along a one-dimensional second tracing path relative to said central revolving axis (199) of the toothed revolving object (190), and the tracing structure is adjustable for adjusting the direction (114, 115) of said one-dimensional second tracing path relative to said central revolving axis (199).

3. A method according to claim 1, wherein:
the tracing structure in said holding condition is adjustable for adjusting an axial tracing position, as seen along said central revolving axis (299) of the toothed revolving object (290), of the first and second tracer fingers (211, 212) relative to the toothed revolving object (290), and
the method is carried out multiple times for said toothed revolving object (290) at a corresponding plurality of mutually adjusted ones of said axial tracing position, respectively, thereby determining a corresponding plurality of different ones of said measured shape, respectively, of a corresponding plurality of different ones of said circumferential toothing contour, respectively.

4. An apparatus (1; 101; 201) for accurately measuring at least part of a circumferential toothing contour (93) of internal or external toothing of a toothed revolving object (90), wherein said circumferential toothing contour occurs in a cross-sectional plane perpendicular to a central revolving axis (99) of the toothed revolving object, and wherein said circumferential toothing contour has a plurality of pairs of mutually opposite first (91) and second (92) contour flanks corresponding to a plurality of pairs of mutually opposite first and second tooth flanks, respectively, of a corresponding plurality of teeth (94) of said toothing, respectively, the apparatus comprising:
an apparatus frame (2),
a holding structure (3) connected to said apparatus frame and configured for effecting a holding condition in which the holding structure is holding the toothed revolving object (90),
a tracing structure connected to said apparatus frame and comprising a first tracer finger (11) and a second tracer finger (12), wherein the first tracer finger comprises a first tracer bevel surface (21) and a first tracer point (31), wherein the first tracer finger by said first tracer bevel surface is asymmetrically narrowing in its longitudinal direction up to said first tracer point, being a free end of the first tracer finger, and wherein the second tracer finger (12) comprises a second tracer bevel surface (22) and a second tracer point (32), wherein the second tracer finger by said second tracer bevel surface is asymmetrically narrowing in its longitudinal direction up to said second tracer point, being a free end of the second tracer finger,
a driving structure (4) configured for effecting in said holding condition a first relative rotation between the toothed revolving object and the first tracer finger (11) in a first rotation direction (41) around said central revolving axis, and for effecting a second relative rotation between the toothed revolving object and the second tracer finger (12) in a second rotation direction (42) around said central revolving axis, wherein said first and second rotation directions are mutually opposite,
a processor (5) for determining a measured shape (6) of said circumferential toothing contour based on detected first relative positions of said first tracer point (31) relative to said toothed revolving object (90) during said first relative rotation, and based on detected second relative positions of said second tracer point (32) relative to said toothed revolving object (90) during said second relative rotation,
and wherein the apparatus is configured for:
performing a first tracing phase, during which the first tracer finger (11) is tracing against and along said circumferential toothing contour (93) by performing said first relative rotation, wherein the first tracing phase comprises:
first tracing subphases, during which the first tracer point (31) is tracing against and along at least said first contour flanks (91), and
first nontracing subphases, during which the first tracer point (31) is prevented from tracing against and along at least part of said second contour flanks (92) in that the first tracer bevel surface (21) is contacting said toothing then,
performing a second tracing phase, during which the second tracer finger (12) is tracing against and along said circumferential toothing contour (93) by performing said second relative rotation, wherein the second tracing phase comprises:
second tracing subphases, during which the second tracer point (32) is tracing against and along at least said second contour flanks (92), and
second nontracing subphases, during which the second tracer point (32) is prevented from tracing against and along at least part of said first contour flanks (91) in that the second tracer bevel surface (22) is contacting said toothing then,
determining, by said processor (5), said measured shape (6) of said circumferential toothing contour (93) based on said first relative positions detected during said first tracing subphases and based on said second relative positions detected during said second tracing subphases.

5. An apparatus (101) according to claim 4, wherein:
the tracing structure is configured for effecting that during said first tracing phase the first tracer finger has a one-dimensional tracing movement freedom along a one-dimensional first tracing path relative to said central revolving axis (199) of the toothed revolving object (190), and the tracing structure is adjustable for adjusting the direction (114, 115) of said one-dimensional first tracing path relative to said central revolving axis (199); and/or
the tracing structure is configured for effecting that during said second tracing phase the second tracer finger has a one-dimensional tracing movement freedom along a one-dimensional second tracing path relative to said central revolving axis (199) of the toothed revolving object (190), and the tracing structure is adjustable for adjusting the direction (114, 115) of said one-dimensional second tracing path relative to said central revolving axis (199).

6. An apparatus (201) according to claim 4, wherein:
the tracing structure in said holding condition is adjustable for adjusting an axial tracing position, as seen along said central revolving axis (299) of the toothed revolving object (290), of the first and second tracer fingers (211, 212) relative to the toothed revolving object (290).

7. A method according to claim 2, wherein:
the tracing structure in said holding condition is adjustable for adjusting an axial tracing position, as seen along said central revolving axis (299) of the toothed revolving object (290), of the first and second tracer fingers (211, 212) relative to the toothed revolving object (290), and
the method is carried out multiple times for said toothed revolving object (290) at a corresponding plurality of mutually adjusted ones of said axial tracing position, respectively, thereby determining a corresponding plurality of different ones of said measured shape, respectively, of a corresponding plurality of different ones of said circumferential toothing contour, respectively.

8. An apparatus (201) according to claim 5, wherein:
the tracing structure in said holding condition is adjustable for adjusting an axial tracing position, as seen along said central revolving axis (299) of the toothed revolving object (290), of the first and second tracer fingers (211, 212) relative to the toothed revolving object (290).
